(19) United States
(12) Patent Application Publication
(10) Pub. No.: US 2004/0091666 A1
(43) Pub. Date: May 13, 2004

(54) Structural composite member

(76) Inventors: Ronald K. Roberts, Dearborn, MI (US); Daniel P. Reed, Warren, MI (US)

Correspondence Address: VISTEON 29074, BRINKS HOFER GILSON & LIONE, P.O. BOX 10395, CHICAGO, IL, 60611, US

(21) Appl. No.: 10/292,555

(22) Filed: Nov. 12, 2002

(51) Int. Cl. B32B 3/10

(52) U.S. Cl. 428/138

(57) ABSTRACT

The present invention is generally directed towards a composite structural member in a motor vehicle. The composite structural member comprises a substrate defining an aperture and a blow molded member, wherein a portion of the blow molded member extends into the aperture to form a retaining member. A portion of the substrate forming the aperture is deformed such that the aperture has an inner dimension and an outer dimension. The composite structural member also has a communication members passing through an aperture in the retention member.

### TECHNICAL FIELD

This invention generally relates to a structural member formed of a metal substrate, reinforced by a blow-molded member. More specifically, this invention relates to a structural member made of a metal coupled to a plastic blow-molded portion.

### BACKGROUND

Today's automotive design seeks new methods of manufacturing lighter components having increased structural rigidity. Such lightweight components find use in automotive components such as vehicle seats, cross bar, support brackets, etc. It is also desirable to reduce the number of components in vehicles such that one component performs more than one function. With regard to vehicle cross car beams, much effort has previously focused on utilizing the structural integrity of the outboard register ducts to support the substrate. These previous designs typically required significant reinforcement with an additional steering column support bracket.

### SUMMARY

In accordance with the preferred embodiment of the present invention, a structural member is formed of a substrate, reinforced by a blow-molded member. In order to retain the blow molded member to the substrate, is provided with an aperture. A portion of the blow-molded member extends into the aperture to form a retention member such that the substrate is mechanically bonded to the blow-molded member.

In yet another aspect of the present invention, the aperture of the substrate is formed such that it defines an inner dimension and an outer dimension; the inner dimension being less than the outer dimension. In yet another aspect of the present invention, the aperture on the substrate can be formed by either mechanically deforming those portions of the substrate defining the aperture or by molding the portions of the substrate defining the aperture to the desired configuration.

In yet another aspect of the present invention, the retention member has an opening such that communication elements can be inserted through the openings.

Further features and advantages of the invention will become apparent to one ordinary skilled in the art from the following discussion and the accompanying drawings.

### BRIEF DESCRIPTION OF THE DRAWINGS

FIG. 1 is a cross sectional view of a portion of a composite structural member, wherein a portion of the substrate forming the aperture is deformed by punching;

FIG. 2 is a cross sectional view of a portion of a composite structural member, wherein a portion of the substrate forming the aperture is formed by molding the substrate;

FIG. 3 is a cross sectional view of a portion of a composite structural member, wherein a portion of the substrate forming the aperture is deformed by punching;

FIG. 4A is a cross sectional view of a portion of a composite structural member, wherein the aperture in the substrate is formed as a tapered bore in the substrate;

FIG. 4B is a cross sectional view of a portion of a composite structural member, wherein the aperture in the substrate is formed as a countersunk bore in the substrate;

FIG. 5 is a cross sectional view of a portion of a composite structural member, wherein the substrate is a PC Board;

FIG. 6A is a cross sectional view of a portion of a composite structural member, wherein the retaining member has a communication member passing through an aperture in the retaining member;

FIG. 6B is a cross sectional view of a second embodiment of the composite structural member of FIG. 6A, wherein the retaining member has a communication member passing through an aperture in the retaining member; and

FIG. 7 is an alternate embodiment of the composite structural member of FIG. 1, wherein the blow molded portion is used to join the two substrates together.

### DETAILED DESCRIPTION

The following description of the preferred embodiment is merely exemplary in nature and is in no way intended to limit the invention or its application or uses.

Referring in particular to the drawings, a composite structural member is generally shown and designated by reference numeral 10. This portion of the composite structural member, hereinafter referred to as structural member 10 can be any structural member in a motor vehicle. For example, the structural member may be a cross beam in an instrument panel in a motor vehicle, headliners, A, B or C pillars or it may be used as a duct for the air conditioning unit in a car. Alternatively, the structural member 10 may be used in other application not relating to motor vehicles such as routing for electrical lines in a building walls etc.

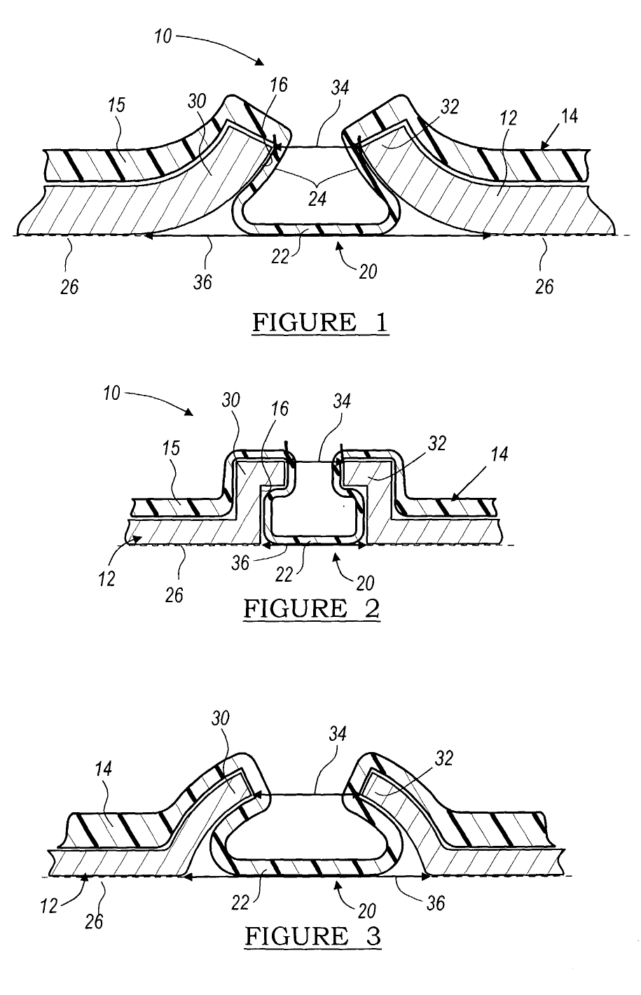

As shown in FIGS. 1, 2 and 3, the structural member 10 comprises a substrate 12 and a blow molded member 14, reinforcing the substrate 12. The blow molded member 14 provides structural integrity to substrate 12. Preferably, the substrate 12 is a sheet metal formed from a suitable metal including aluminum, iron, copper or alloys thereof. Preferably, the blow molded member 14 is formed from materials such as plastic, plastic composite or thermoplastic resin such as PET or nylon.

In order to mechanically bond the blow molded member 14 to the substrate 12, the substrate 12 has an aperture 16. Although through this application a single aperture 16 is shown and discussed, it must be understood that the substrate 12 may define a plurality of apertures 16. A portion of the blow molded member 14 extends into the aperture 16 to define a retention member 20. The retention member 20 provides the necessary mechanical bond to hold the blow molded member 14 to the substrate 12. As shown in FIG. 1, the retention member 20 has a base or a bottom 22 and arms 24 extending from the base 22 engulfing the aperture 16 and merging with a body portion 15 of the blow molded member 14.

In order for the blow molded member 14 to form the retention member 20, the portion of the substrate 12 defining the aperture 16 is formed such that the aperture 16 defines an inner dimension, represented by reference numeral 34 and an outer dimension, represented by reference numeral 36. As used herein, the inner dimension 34 is located towards the side of the substrate 12 that is immediately adjacent to the blow molded member 14. The outer dimension 36 is located towards the opposite side of the substrate 12. Preferably, the outer dimension 36 is larger than the inner dimension 34.

So as to form the retention member 20 and effectively retain the blow molded member 14 to the substrate 12 the portions of the substrate 12 defining the aperture 16 may be formed using a number of different techniques. For example, as shown in FIG. 1, an initial aperture may be laser cut or otherwise formed in the substrate 12 and the portions defining the aperture 16 deformed as indicated at 30 and 32 by punching the substrate 12. Depending on the shape of the punching tool used, the deformed portions 30 and 32 may be outwardly convex. On the other hand, as shown in FIG. 3, the deformed portions 30, 32 depending on the punching tool, can be outwardly concave in shape. In yet another example shown in FIG. 2, the portions 30, 32 defining the aperture 16 are formed by molding the substrate 12. Here the portions 30, 32 are formed into an inverted L-shaped when viewed in cross-section. In all the examples shown above, the inner dimension 34 of aperture 16 is smaller than the outer dimensions 36 of aperture 16.

By forming the aperture 16 as described above, when the blow molded member 14 is being blow molded, a portion of the material forming the blow molded member 14 will be blown into the aperture 16. As this portion is expanded by the blow molding medium, the portion expands forming the bulb like retention member 20 within the aperture 16. In the preferred embodiments and as clearly shown in FIGS. 1, 2 and 3, the base 22 of the retention member 20 is flush with the exterior surface 26 of the substrate 12, such that the retention member 20 does not protrude out of the aperture 16. Formed in this manner, the structural member 10 lends itself to easier manufacturing and removal from the mold in which it was formed.

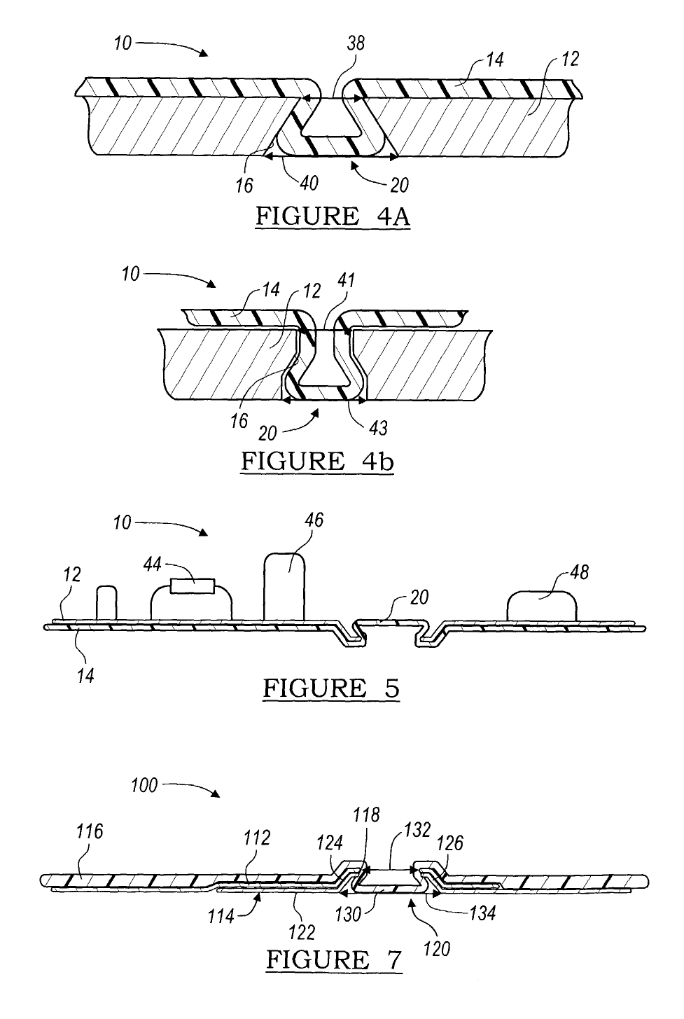

Referring in particular to FIGS. 4A and 4B, further embodiments of the aperture 16 are seen therein. These embodiments, which can be used instead of the previously discussed embodiments are especially preferred where a thick substrate is used. When the substrate 12 is thick it may be difficult to deform or shape a portion of the substrate forming the previously discussed aperture 16. As clearly shown in FIG. 4A, the aperture 16 is provided as a tapered bore such that the inner dimension 38 of the tapered bore is smaller than the outer dimension 40. On the other hand, as shown in FIG. 4B, the aperture 16 is provided as countersunk bore, wherein the aperture 16 again defines an inner dimension 41 and an outer dimension of 43. Such bores may be drilled into the substrate 12 or they may be formed as such during forming of the substrate 12.

The structural member 10 having the structure defined above can be used in a variety of different ways. One such use is shown in FIG. 5, wherein the substrate 12 is a PC Board 42. Alternatively, a circuit board may be mounted to the substrate 12. As shown, a number of electronic components such as a resistor 44, a transmitter 46, a capacitor 48 may be mounted on the substrate 12. Although not shown in the drawings, a printed circuit may be etched to the surface of the substrate 12 such that the composite structural member may function as an electronic component.

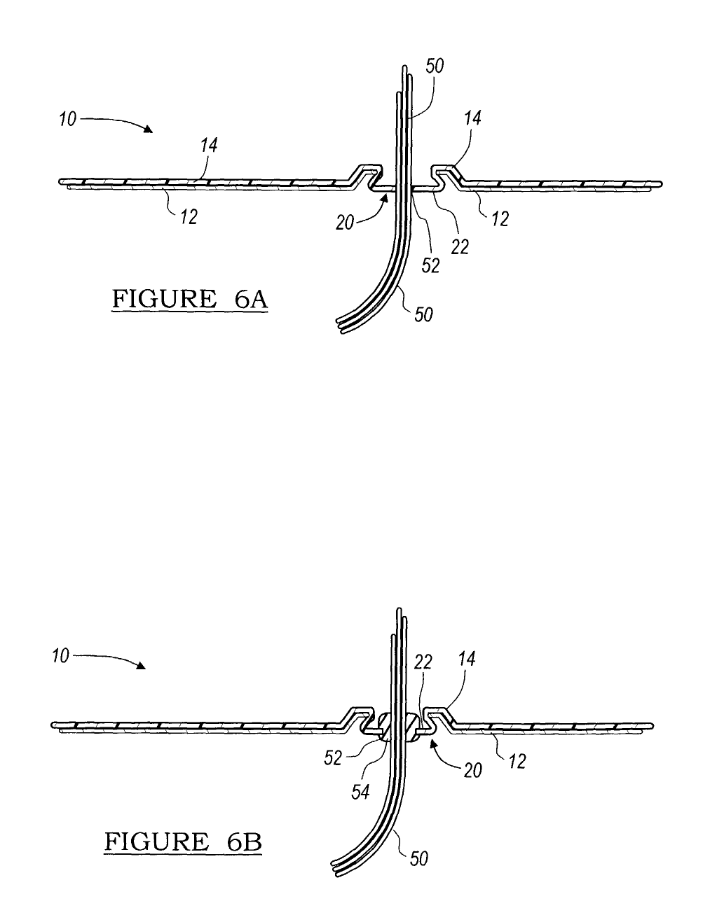

FIGS. 6A and 6B illustrate yet another application of the structural member 10, wherein communication members 50 can be passed through the retention member 20. In this invention, communication members 50 are referred to any members that are used to transport fluids, air or electrical current or signal to various other components in motor vehicles. Such communication members 50 may be wires, conduits or fiber optics or light conducting channels. In order to pass communication members 50 through the structural member 10, the base 22 of the retention member 20 is provided with an aperture 52. The aperture 52 is formed by drilling or using other means, through the base 22 of the retention member 20 and passing the communication members 52 through the aperture 52. Alternatively, other known techniques can be used to form the aperture 52 on the retaining member 20. In FIG. 6B, the aperture 52 at the bottom 22 of the retention member 20 is filled with a cushion member 54 to protect the communication members 50 from vibrating or rubbing against the blow molded member 14.

FIG. 7 represents an alternate embodiment of the structural member 10 discussed above. As shown in the Figure, the structural member 100 comprises a first substrate 112, a second substrate 114 and a blow molded member 116 reinforcing and retaining the first substrate 112 and second substrate 114 together. similar to the previous embodiment, the first substrate 112 and the second substrate 114 define an aperture 118 from portions of the substrates 112 and 114. A portion of the blow molded member extends into the aperture 118 to form a retention member 120. The retention member 120 mechanically bonds the first substrate 112 and the second substrate 114 to the blow molded member 116. As in the prior embodiments, the retention member 120 defines a base or a bottom 130 that is flush with the exterior of the substrates 112, 114. The aperture 118 similarly defines an inner dimension 132 and an outer dimension 134. In order to form the retention member 120 in the aperture 118, it is preferred that the inner dimension 132 of the deformed portions is smaller than exterior dimension 134. As seen in FIG. 7, the first substrate 112 partially overlaps the second substrate 114 in the region 124, 126 surrounding the aperture 118. One or both the substrate 112, 114 are in contact with the blow molded member 116 and one of the substrate could be a PC board mentioned above. The composite structural member 100 is identical to the composite structural member in all other ways and is capable of performing the functions described above.

As a person skilled in the art will recognize from the previous description and from the figures and claims, modifications and changes can be made to the preferred embodiment of the invention without departing from the scope of the invention as defined in the following claims.

What is claimed is:

1. A composite structural member comprising:
a substrate, portions of the substrate defining an aperture;
a blow molded member in contact with the substrate; and
a retaining member formed by a portion of the blow molded member, the retaining member extending into the aperture and mechanically retaining the substrate to the blow molded member.

2. The composite structural member of claim 1, wherein the retaining member is formed flush with a surface of the substrate opposite of the surface in contact with the blow molded member.

3. The composite structural member of claim 1, wherein the portions defining the aperture are formed by shaping the substrate in the area of those portions.

4. The composite structural member of claim 1, wherein the portions defining the aperture are formed by molding the substrate in the area of those portions.

5. The composite structural member of claim 1, wherein the portions defining the aperture are formed by deforming the substrate in the area of those portions.

6. The composite structural member of claim 1, wherein the aperture defines an inner dimension and an outer dimension.

7. The composite structural member of claim 6, wherein the inner dimension is adjacent the blow molded member and is less than the outer dimension.

8. The composite structural member of claim 1, wherein the aperture is defined as a tapered bore.

9. The composite structural member of claim 1, wherein the aperture is defined as a countersunk bore.

10. The composite structural member of claim 1, wherein the substrate is formed of a material selected from a group consisting of aluminum, copper, or alloys thereof.

11. The composite structural member of claim 1, wherein the substrate is a PC board.

12. The composite structural member of claim 1, further comprising communication members passing through an aperture in the retention member.

13. The composite structural member of claim 12, wherein the aperture in the retention member is formed through a portion of the retention member that is flush with the substrate.

14. The composite structural member of claim 12, wherein a cushion member is located within the aperture in the retention member and wherein the communication members extend through the cushion member.

15. The composite structural member of claim 1, wherein the substrate is a first substrate and further comprising a second substrate, the second substrate being retained to the first substrate by the retaining member.

16. The composite structural member of claim 15, wherein the second substrate is a PC board.

17. A composite structural member installed in a motor vehicle, the structural member comprising:
a first substrate;
a second substrate mounted on top of the first substrate, wherein the first substrate and the second substrate cooperate to define an aperture; and
a blow molded member, wherein a portion of the blow molded member extends into the aperture to form a retaining member;
wherein the retaining member mechanically bonds the first substrate to the second substrate.

18. The structural member of claim 17, wherein portions of the first and second substrate defining the aperture are shaped out of plane with the first and second substrates.

19. The structural member of claim 18, wherein the portions defining the aperture are formed by molding.

20. The structural member of claim 18, wherein the portions defining the aperture are formed by mechanical deformation of the first and second substrates.

21. The structural member of claim 17, wherein the aperture defines an inner dimension and an outer dimension, the inner dimension being less than the outer dimension.

22. The structural member of claim 17, wherein the aperture is a tapered bore.

23. The structural member of claim 17, wherein the aperture is a countersunk bore.

24. The structural member of claim 17, further comprising communication members passing through an aperture in the retention member.

25. The structural member of claim 24, wherein the aperture in the retention member is formed at the base of the retention member.

26. The structural member of claim 24, wherein the aperture in the retention member further comprises a cushion member, wherein the communication members are positioned between the cushion member.
